(19) United States
(12) Patent Application Publication
(10) Pub. No.: US 2020/0350116 A1
(43) Pub. Date: Nov. 5, 2020

(54) TRANSFORMER AND POWER CONVERSION DEVICE

(71) Applicant: Mitsubishi Electric Corporation, Chiyoda-ku, Tokyo (JP)

(72) Inventors: Takayuki KAWAGUCHI, Tokyo (JP); Tomoki WATANABE, Tokyo (JP); Yumi NAJIMA, Tokyo (JP)

(73) Assignee: Mitsubishi Electric Corporation, Chiyoda-ku, Tokyo (JP)

(21) Appl. No.: 16/758,625

(22) PCT Filed: Nov. 8, 2017
(86) PCT No.: PCT/JP2017/040207

§ 371 Date: Apr. 23, 2020

(51) Int. Cl. H01F 27/29; H01F 27/28; H01F 27/24

(52) U.S. Cl. CPC H01F 27/29; H01F 27/24; H01F 27/2876

(57) ABSTRACT

A transformer includes: a base that is a plate-like member and has a first surface and a second surface, a core attached to the first surface of the base, coils wound around the core, coil terminals attached to the second surface of the base, and a cooling unit that is thermally connected to the core and is to release heat transferred from the core. The coil terminals are disposed on the second surface of the base opposite to the first surface of the base to which the core is attached. The cooling unit is disposed on a side of the core opposite to the base.

### TECHNICAL FIELD

The present disclosure relates to a transformer and a power conversion device including the transformer.

### BACKGROUND ART

An electric railway vehicle is equipped with a power conversion device that converts input DC power or input AC power into desired power and outputs the converted power. For example, an auxiliary power supply device converts power input from an overhead wire and outputs desired power suitable for a load device such as an air conditioner or a lighting device. The power conversion device includes, for example, a transformer disclosed in Patent Literature 1.

### CITATION LIST

### Patent Literature

Patent Literature 1: Unexamined Japanese Patent Application Kokai Publication No. H08-102423

### SUMMARY OF INVENTION

### Technical Problem

When the power conversion device performs power conversion, the transformer generates heat. The power conversion device mounted on the electric railway vehicle has a larger capacity than power conversion devices for general industrial use and has a large amount of heat generated by the transformer. Therefore, in order to cool the transformer, for example, the transformer is exposed to ambient air, the power conversion device is provided with a blower to blow air to the transformer. In a case in which cooling of the transformer is insufficient even if the transformer is cooled as described above, cooling capacity is to be enhanced, for example, by using a blower with higher cooling capacity. Alternatively, loss in the transformer is to be reduced and heat generation due to the transformer is to be suppressed by enlarging the core or increasing the number of turns of a coil. As described above, although the cooling capacity of the transformer can be improved and the heat generation can be suppressed, the power conversion device has a further problem in that volumes and weights of the transformer and the blower increase.

In order to solve the aforementioned problem, an objective of the present disclosure is to improve cooling capacity while suppressing an increase in the size of a transformer.

### Solution to Problem

In order to achieve the aforementioned objective, a transformer according to the present disclosure includes a base that is a plate-like member and has a first surface and a second surface, a core, coils, coil terminals, and a cooling unit. The core is attached to the first surface of the base. The coils are wound around the core. The coil terminals are each electrically connected to one end of a corresponding coil of the coils, and are disposed on the second surface opposite to the first surface to which the core is attached. The cooling unit is disposed on a side of the core opposite to the base, is thermally connected to the core, and is to release heat transferred from the core.

### Advantageous Effects of Invention

According to the present disclosure, the transformer is provided with the cooling unit that is thermally connected to the core and releases heat transferred from the core, thereby enabling improvement of the cooling capacity while suppressing the increase in the size of the transformer.

### BRIEF DESCRIPTION OF DRAWINGS

FIG. 1 is a perspective view illustrating a transformer according to an embodiment of the present disclosure;

FIG. 2 is a cross-sectional view illustrating a power conversion device according to the embodiment;

FIG. 3 is a drawing of the transformer according to the embodiment as viewed from a closed section;

FIG. 4 is a perspective view illustrating a first modified example of the transformer according to the embodiment;

FIG. 5 is a perspective view illustrating a second modified example of the transformer according to the embodiment;

FIG. 6 is a perspective view illustrating a third modified example of the transformer according to the embodiment; and

FIG. 7 is a drawing illustrating another example of a placement of the transformer according to the embodiment.

### DESCRIPTION OF EMBODIMENTS

An embodiment of the present disclosure is described below in detail with reference to the drawings. Components that are the same or equivalent are assigned the same reference signs throughout the drawings.

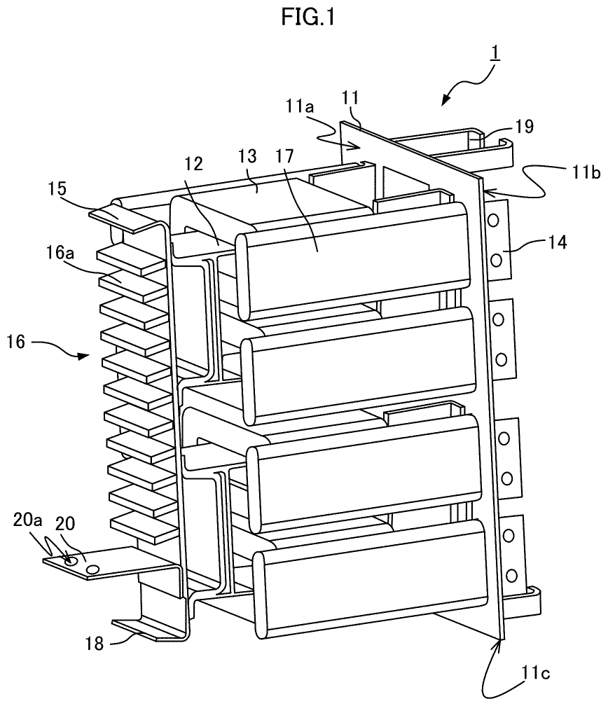

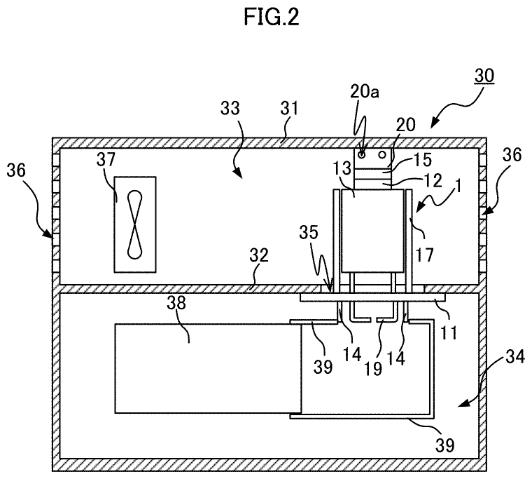

FIG. 1 is a perspective view illustrating a transformer according to an embodiment of the present disclosure. FIG. 2 is a cross-sectional view illustrating a power conversion device according to the embodiment. A power conversion device 30 including a transformer 1 is mounted on an electric railway vehicle. FIG. 2 is a view illustrating the power conversion device 30 as viewed from above in the vertical direction. The power conversion device 30 is mounted under a floor of the electric railway vehicle, for example, by a hanging clasp that is not illustrated in the drawings.

The transformer 1 includes a base 11 that is a plate-like member, a core 12 attached to a first surface 11a of the base 11, coils 13 wound around the core 12, coil terminals 14 attached to a second surface 11b of the base 11, and a cooling unit 16 that is thermally connected to the core 12 and releases heat transferred from the core 12. The first surface 11a of the base 11 extends in the vertical direction. In the example of FIG. 1, the first surface 11a of the base 11 is parallel to the vertical direction, and the core 12 included in the transformer 1 is a plurality of cores. The coils 13 are wound around the cores 12. In the example of FIG. 1. the coils 13 are wound around the cores 12 in such a manner that a central axis of each of the coils 13 extends in a direction orthogonal to the first surface 11a of the base 11. The coil terminals 14 are each electrically connected to one end of the corresponding coil 13 of the coils 13. The coil terminals 14 are disposed on the second surface 11b of the base 11 opposite to the first surface 11a to which the core 12 is attached. One ends of the coils 13 pass through the interior of an insulating member 17 and the base 11 and are connected to the coil terminals 14 disposed on the second surface 11b. The cooling unit 16 is disposed on a side of the core 12 opposite to the base 11.

In the example of FIG. 1, the transformer 1 includes the cores 12 and further includes a fixing frame 15 to which the cores 12 are fixed. The fixing frame 15 has a thermal conductivity for transferring heat generated by the core 12 to the cooling unit 16 and is made of a material having a strength required for fixing the core 12, for example, stainless steel. The cooling unit 16 has a fin-like shape and releases heat transferred from the core 12 via the fixing frame 15. In the example of FIG. 1, the cooling unit 16 has fins 16a extending in the horizontal direction. The fins 16a are attached to the fixing frame 15 at intervals in the vertical direction. The cooling unit 16 is made of a material such as aluminum in accordance with cooling capacity desired for the transformer 1.

The fixing frame 15 is a plate-like member extending in the vertical direction as illustrated in FIG. 1 and may have a slide portion 18 that (i) extends away from the base 11 at the vertically lower end of the fixing frame 15 and (ii) has an edge located at a position, in the vertical direction, higher than a position of the vertically lower end of the fixing frame 15. The slide portion 18 forms a slide surface of a vertically lower portion of the transformer 1, thereby facilitating easy movement of the transformer 1 in the horizontal direction by pushing a handle 19. In addition to the slide portion 18, a third surface 11c that is a surface on the vertically lower side and orthogonal to the first surface 11a and the second surface 11b of the base 11 may also form a slide surface of the vertically lower portion of the transformer 1. Additionally, as in the example of FIG. 1, the fixing frame 15 may be provided with a locking member 20. The locking member 20 has locking holes 20a. For example, movement of the transformer 1 inside the power conversion device 30 is suppressed by the locking member 20 engaging protrusions of the power conversion device 30 (not illustrated in the drawings) via the locking holes 20a.

The power conversion device 30 includes a housing 31 accommodating the transformer 1 and an electronic circuit 38 illustrated in FIG. 1. The housing 31 is divided by a partition 32 into (i) an open section 33 through which an ambient air flow passes and (ii) a closed section 34 through which an ambient air flow does not pass. The partition 32 has an opening 35. Vents 36 are formed on surfaces of the housing 31 facing the open section 33. A blower 37 is disposed in the open section 33. Operation of the blower 37 causes air flowing in from the vent 36 to come into contact with the cooling unit 16, and the cooling unit 16 releases, into the air, heat transferred from the core 12. The blower 37 may be omitted and the transformer 1 may be naturally cooled by a wind caused by movement of the railway vehicle on which the power conversion device 30 is mounted. The orientations of the fins 16a may be determined in accordance with the flow of air in the open section 33. The electronic circuit 38 is accommodated in the closed section 34. The electronic circuit 38 is electrically connected to the coil terminals 14 by a conductor 39 that is, for example a copper bar. The electronic circuit 38 is, for example, a filter circuit disposed on the primary side of the transformer 1, an inverter circuit disposed on the secondary side of the transformer 1, or the like,

The transformer 1 is accommodated in the housing 31 such that (i) the core 12, the coil 13, and the cooling unit 16 are disposed in the open section 33 and (ii) the coil terminals 14 are disposed in the closed section 34, and the base 11 of the transformer 1 covers the opening 35 formed in the partition 32. By accommodating the transformer 1 as described above, the core 12 requiring cooling is located in the open section 33, and the coil terminals 14 requiring insulation protection are located in the closed section 34. The transformer 1 is inserted into the interior of power conversion device 30 from an inspection port formed in the housing 31 and not illustrated in the drawings. As described above, fanning of the slide surface by the slide portion 18 facilitates easy pushing of the transformer 1 into the interior of the power conversion device 30 and improves the maintainability of the power conversion device 30. As described above, since the position of one end of the slide portion 18 in the vertical direction is higher than the position of the vertically lower end of the fixing frame 15, when the transformer 1 is pushed into the interior of the power conversion device 30, the transformer 1 is inhibited from getting caught on the bottom surface of the housing 31. For example, the transformer 1 is inserted into the interior of the power conversion device 30 from the inspection opening that is formed in the housing 31 located on the lower side in FIG. 2, and the first surface 11a of the base 11 is pushed until the first surface 11a abuts the partition 32.

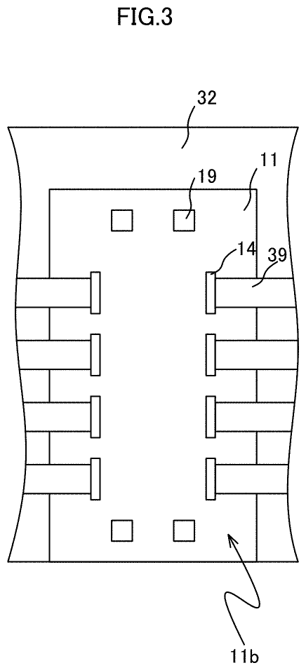

FIG. 3 is a drawing of the transformer according to the embodiment as viewed from the closed section. The base 11 of the transformer 1 covers the opening 35, thereby separating the open section 33 and the closed section 34 from each other. That is, an additional member is not needed for separating the open section 33 and the closed section 34 from each other. Additionally, a member is not needed for blocking the entry of dust, water or the like in the open section 33 into the closed section 34, such as a cable gland. Therefore, reductions in size and weight of the power conversion device 30 and improvement of maintainability of the power conversion device 30 are possible. Any material can be used for making the base 11 as long as the open section 33 and the closed section 34 can be separated from each other. The base 1 may be made of metal material or non-metal material. Packings are attached to all the surfaces of the base 11 that are orthogonal to the first surface 11a and the second surface 11b and include the third surface 11c, thereby enabling improvement of enclosure performance of the closed section 34. Alternatively, a packing is attached around the opening 35, thereby enabling improvement of the enclosure performance of the closed section 34.

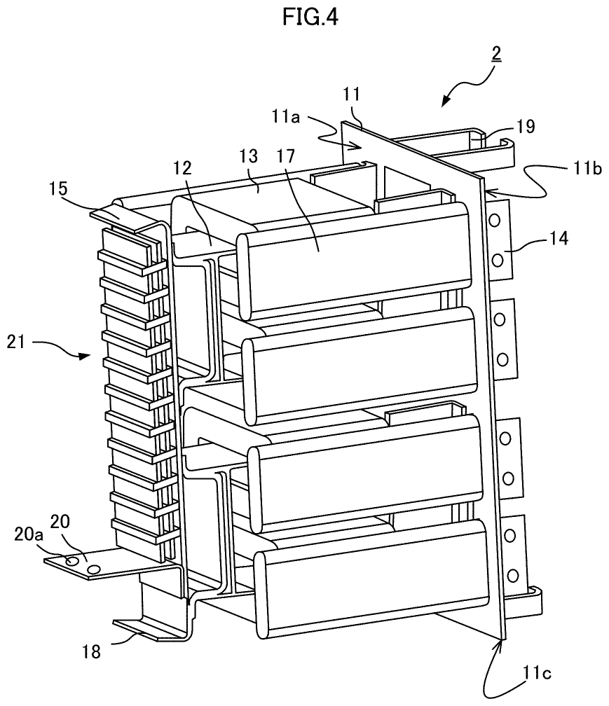

FIG. 4 is a perspective view illustrating a first modified example of the transformer according to the embodiment. A transformer 2 illustrated in FIG. 4 includes a cooling unit 21 instead of the cooling unit 16 of the transformer 1 illustrated in FIG. 1. The cooling unit 21 has a lattice-like shape. Since the surface area of the cooling unit 21 is larger than the surface area of the cooling unit 16 having a fin-like shape, the cooling capacity of the transformer 2 improves.

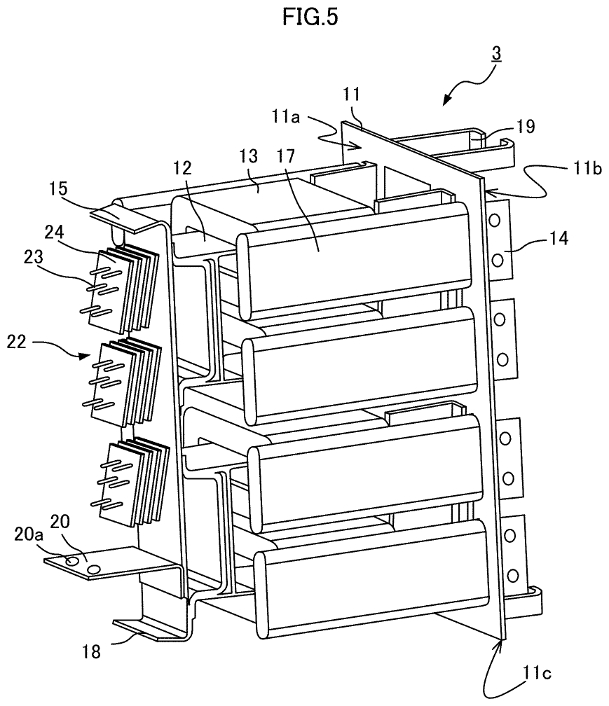

FIG. 5 is a perspective view illustrating a second modified example of the transformer according to the embodiment. A transformer 3 illustrated in FIG. 5 includes a cooling unit 22 instead of the cooling unit 16 of the transformer 1 illustrated in FIG. 1. The cooling unit 22 includes (i) heat pipes 23 in which refrigerant is enclosed and (ii) fins 24 each attached to the heat pipes 23.

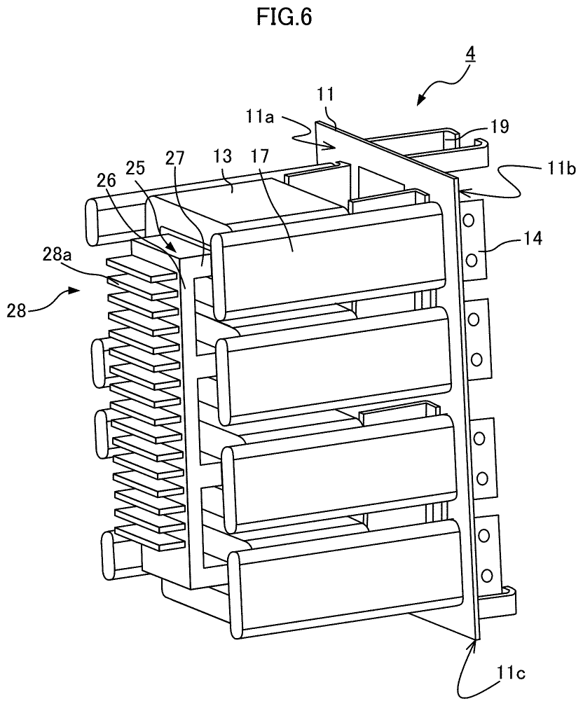

FIG. 6 is a perspective view illustrating a third modified example of the transformer according to the embodiment. A transformer 4 illustrated in FIG. 6 includes one core 25 instead of the cores 12 of the transformer 1 illustrated in FIG. 1. The core 25 has (i) a pair of end portions 26 extending in parallel with the first surface 11a of the base 11 and (ii) legs 27 connecting the pair of end portions 26. Additionally, the transformer 4 illustrated in FIG. 6 has a cooling unit 28 instead of the cooling unit 16 of the transformer 1 illustrated in FIG. 1. The cooling unit 28 is directly attached to the core 25 and releases heat transferred from the core 25. In the example of FIG. 6, the cooling unit 28 includes fins 28a extending in the horizontal direction. The fins 28a are attached to the core 25 at intervals in the vertical direction. The orientations of the fins 28a can be determined in accordance with the flow of air in the open section 33. The shape of the cooling unit 28 is not limited to the fin-like shape and may be a lattice-like shape like the cooling unit 21 of the transformer 2 illustrated in FIG. 4. Alternatively, the cooling unit 28 may include the heat pipes 23 and fins 24 like the cooling unit 22 illustrated in FIG. 5.

As described above, the transformers 1, 2 and 3 according to the embodiment respectively include the cooling units 16, 21 and 22 each of which is thermally connected to the core 12 and releases heat transferred from the core 12 via the fixing frame 15, thereby enabling improvement of the cooling capacity while suppressing an increase in the sizes of the transformers 1, 2 and 3. Additionally, the transformer 4 according to the embodiment includes the cooling unit 28 that is directly connected to one core 25 and releases heat transferred from the core 25, thereby enabling improvement of the cooling capacity while suppressing an increase in the size of the transformer 4.

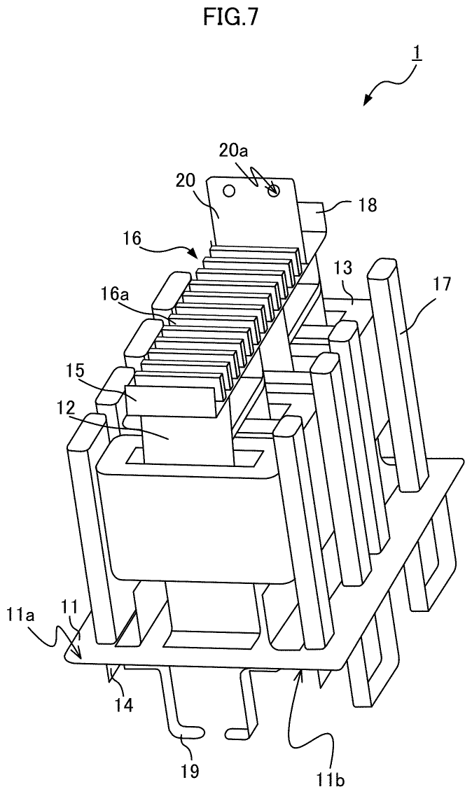

Embodiments according to the present disclosure are not limited to the above-described embodiment. The orientation in which the transformer 1 is placed is not limited to the above-described example. FIG. 7 is a drawing illustrating another example of placement of the transformer according to the embodiment. The transformer 1 may be placed such that the first surface 11a and the second surface 11b of the base 11 are orthogonal to the vertical direction. The same applies to the transformers 2, 3 and 4. The power conversion device 30 including the transformer 1 illustrated in FIG. 7 includes the open section 33 located in the vertically upper portion and the closed section 34 located in the vertically lower portion. The transformer 1 may be inserted into the interior of the power conversion device 30 from the inspection port formed in the vertically lower surface of the housing 31 of the power conversion device 30. The shapes of the cores 12 and 25 are not limited to those of the above-described examples. The number of coils 13 is freely selected as two or more. Additionally, the method of winding the coil 13 around the cores 12 and 25 is not limited to the above-mentioned examples.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a. restrictive sense. This detailed description, therefore, is not to be taken in a limiting sense, and the scope of the invention is defined only by the included claims, along with the full range of equivalents to which such claims are entitled.

### REFERENCE SIGNS LIST

1, 2, 3, 4 Transformer
11 Base
11a First surface
11b Second surface
11c Third surface
12, 25 Core
13 Coil
14 Coil terminal
15 Fixing frame
16, 21, 22, 28 Cooling unit
16a, 24, 28a Fin
17 Insulating member
18 Slide portion
19 Handle
20 Locking member
20a Locking hole
23 Heat pipe
26 End portion
27 Leg
30 Power conversion device
31 Housing
32 Partition
33 Open section
34 Closed section
35 Opening
36 Vent
37 Blower
38 Electronic circuit
39 Conductor

1. A transformer comprising:
a base that is a plate-like member and has a first surface and a second surface;
a core attached to the first surface of the base;
coils wound around the core; and
coil terminals that are each electrically connected to one end of a corresponding coil of the coils and are disposed on the second surface opposite to the first surface of the base to which the core is attached.

2-8. (canceled)

9. The transformer according to claim 1 further comprising:
a cooling unit that is disposed on a side of the core opposite to the base, is thermally connected to the core, and is to release heat transferred from the core.

10. The transformer according to claim 9, wherein
the core is a plurality of cores,
the transformer further comprises a fixing frame disposed on a side of the cores opposite to the base, the cores being fixed to the fixing frame, and
the cooling unit is attached to the fixing frame and is to release heat transferred from the cores via the fixing frame.

11. The transformer according to claim 10, wherein
the first surface of the base extends in a vertical direction, and
the fixing frame is a plate-like member extending in the vertical direction and includes a slide portion that (i) extends away from the base at a vertically lower end of the fixing frame and (ii) has an edge located at a position, in the vertical direction, higher than a position of the vertically lower end of the fixing frame.

12. The transformer according to claim 10, wherein the cooling unit is directly attached to the core and releases heat transferred from the core.

13. The transformer according to claim 9, wherein the cooling unit has a fin-like shape.

14. The transformer according to claim 10, wherein the cooling unit has a fin-like shape.

15. The transformer according to claim 11, wherein the cooling unit has a fin-like shape.

16. The transformer according to claim 12, wherein the cooling unit has a fin-like shape.

17. The transformer according to claim 9, wherein the cooling unit has a lattice-like shape.

18. The transformer according to claim 10, wherein the cooling unit has a lattice-like shape.

19. The transformer according to claim 11, wherein the cooling unit has a lattice-like shape.

20. The transformer according to claim 12, wherein the cooling unit has a lattice-like shape.

21. The transformer according to claim 9, wherein the cooling unit comprises a heat pipe in which refrigerant is enclosed.

22. The transformer according to claim 10, wherein the cooling unit comprises a heat pipe in which refrigerant is enclosed.

23. The transformer according to claim 11, wherein the cooling unit comprises a heat pipe in which refrigerant is enclosed.

24. The transformer according to claim 12, wherein the cooling unit comprises a heat pipe in which refrigerant is enclosed.

25. A power conversion device comprising:
the transformer according to claim 1;
an electronic circuit electrically connected to the coil terminals; and
a housing to accommodate the transformer and the electronic circuit,
wherein
an interior of the housing is divided by a partition into (i) an open section through which an ambient air flow passes and (ii) a closed section through which an ambient air flow does not pass,
the partition has an opening,
the electronic circuit is accommodated in the closed section,
the transformer is accommodated in the housing such that (i) the core and the coils are located in the open section and (ii) the coil terminals are located in the closed section, and
the base of the transformer covers the opening of the partition.

26. A power conversion device comprising:
the transformer according to claim 9;
an electronic circuit electrically connected to the coil terminals; and
a housing to accommodate the transformer and the electronic circuit,
wherein
an interior of the housing is divided by a partition into (i) an open section through which an ambient air flow passes and (ii) a closed section through which an ambient air flow does not pass,
the partition has an opening,
the electronic circuit is accommodated in the closed section,
the transformer is accommodated in the housing such that (i) the core, the coils, and the cooling unit are located in the open section and (ii) the coil terminals are located in the closed section, and
the base of the transformer covers the opening of the partition.

27. A power conversion device comprising:
the transformer according to claim 10;
an electronic circuit electrically connected to the coil terminals; and
a housing to accommodate the transformer and the electronic circuit,
wherein
an interior of the housing is divided by a partition into (i) an open section through which an ambient air flow passes and (ii) a closed section through which an ambient air flow does not pass,
the partition has an opening,
the electronic circuit is accommodated in the closed section,
the transformer is accommodated in the housing such that (i) the core, the coils, and the cooling unit are located in the open section and (ii) the coil terminals are located in the closed section, and
the base of the transformer covers the opening of the partition.
